(19) United States
(12) Patent Application Publication
(10) Pub. No.: US 2026/0206743 A1
(43) Pub. Date: Jul. 23, 2026

(54) PROPINEB NANOSUSPENSION

(71) Applicant: Ziyong Zhang, Nanjing (CN)

(72) Inventors: Ziyong Zhang, Nanjing (CN); Bing Liang, Nanjing (CN)

(21) Appl. No.: 19/139,375

(22) PCT Filed: Nov. 2, 2023
(86) PCT No.: PCT/CN2023/129390

§ 371 Date: Jun. 16, 2025

(30) Foreign Application Priority Data
Dec. 18, 2022 (WO) PCT/CN2022/139831

(51) Int. Cl. A01N 25/04; A01N 47/14; A01P 3/00

(52) U.S. Cl. CPC A01N 25/04; A01N 47/14; A01P 3/00

(57) ABSTRACT

The present invention belongs to the field of nanopesticides, and relates to a propineb nanosuspension which has a particle size that is smaller than 100 nanometers and a preparation method therefor. In the present invention, two or three components are diluted and mixed with water to form a propineb nanosuspension which has a particle size of smaller than 100 nanometers. The preparation method comprises: under the condition that the stirring speed is not smaller than an effective stirring speed, adding a dilute solution of component I into a dilute solution of component II, or adding the dilute solution of component II into the dilute solution of component I to form a propineb compound nanosuspension.

### TECHNICAL FIELD

The present invention relates to the field of nanopesticides, and more particularly to the preparation of nanosuspensions with particle sizes smaller than 100 nanometers.

### BACKGROUND ART

Enhancing efficacy is one of the most important approaches to reducing pesticide use, and the development of nanopesticides is the most promising method. Nanopesticides emerged in the early 21st century as a strategy to reduce the particle size of pesticide formulations using nanotechnology and achieve nanoscale dispersion. “Nano” (nm) is a unit of length; one nanometer is one-billionth of a meter, or one-millionth of a millimeter. Simply put, nanopesticides refer to pesticide formulations in which the particle size of the active ingredients is in the nanometer range during application. From the perspectives of application performance and stability, it is ideal for the particle size to be smaller than 100 nm—the smaller, the better.

Currently, conventional pesticide formulations have particle sizes at the micron level. If the particle size is reduced to the nanometer scale, the particle diameter is reduced by a factor of 1,000, theoretically increasing the number of particles by one billion times and the surface area by 1,000 times. This is the rationale for developing nanopesticides.

In April 2019, on its 100th anniversary, the International Union of Pure and Applied Chemistry (IUPAC) ranked “Nanopesticides” first among the “Top Ten Innovations in Chemistry That Will Change the World.” Nanopesticides are recognized for their superior target delivery efficiency and better bioavailability. They address the major drawbacks of conventional pesticides, such as environmental pollution, bioaccumulation, and the rapid increase of resistance in pests and pathogens, while significantly reducing the required application dose. Therefore, nanopesticides are considered a key technological direction for the next generation of pesticide formulations.

Propineb, developed by Bayer AG (Germany), is a non-specific multi-site fungicide and a major product following the success of mancozeb. Unlike other dithiocarbamate-based fungicides, Propineb does not contain manganese ions. Its molecular structure includes an additional methyl group on the toxic moiety, which enhances hydrophobicity and improves biological activity. This unique molecular structure and fungicidal mechanism reduce the likelihood of resistance development. Like other dithiocarbamate fungicides, Propineb acts as a protective fungicide with preventive action, but it offers a broader spectrum of activity, more stable efficacy, and superior fungicidal performance.

Its mode of action selectively targets fungal cell wall and protein synthesis, inhibits spore germination and penetration, and simultaneously suppresses hyphal growth, causing deformation and death of the fungi. Moreover, Propineb contains zinc, which is readily absorbed by crops and contributes to plant growth and fruit quality improvement.

The chemical name of Propineb is poly [1,2-propylene bis(dithiocarbamate)] zinc. Its chemical structure is shown in Formula (1). The pure compound is a white powder with a slightly characteristic odor and decomposes above 150° C. As a polyvalent metal salt, it is practically insoluble in water and common organic solvents. At 20° C., its solubility in water is <0.01 g/L. Its solubility in organic solvents (g/L) is <0.1 for toluene, hexane, and dichloromethane; only in a DMF+DMSO mixture does the solubility exceed 200 g/L. It is stable under dry conditions but decomposes in humid, acidic, or alkaline environments.

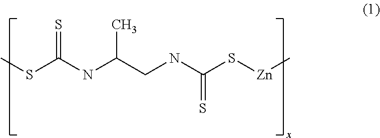

Propineb is a foliar fungicide with protective properties. It exerts its fungicidal effect by contact, killing conidia and developing conidia. It can be applied to most crops, including fruit trees, tea, vegetables, flowers, medicinal herbs, potatoes, and rice, for the control of various diseases. It is particularly effective against leaf spot, speckled leaf drop, downy mildew, phytophthora blight, anthracnose, rust, and other foliar diseases. It also provides protection for zinc-sensitive crops such as rice. For many years, Bayer has widely promoted propineb in China under the trade name Antracol (70% wettable powder). Currently, more than fifty agrochemical companies in China produce single-agent propineb products, mainly in the form of wettable powders, with a few water-dispersible granules. Moreover, no fewer than a hundred companies manufacture mixture formulations of propineb with other pesticides, using the same formulation types. Due to the high content of active ingredients in these formulations—up to 70%-80%—the available space for dispersants and adjuvants is limited. As a result, the particles are in close contact and tend to aggregate and crystallize, leading to relatively large particle sizes.

Propineb can be mixed with a variety of pesticides to produce combination formulations that enhance disease control. However, whether used alone or in mixtures, due to its physical properties—insoluble in both water and organic solvents—its main formulations remain traditional wettable powders and water-dispersible granules. According to current formulation technology, the minimum particle size of the pesticide in such products is usually several microns, with some reaching more than ten or even several tens of microns. The large particle size limits the efficacy of propineb, and combined with the partial resistance resulting from long-term use, the current application rates per unit area are high, typically 750 to 2250 grams of active ingredient per hectare. Therefore, improving its efficacy and reducing the per-hectare usage rate have become important goals in formulation development for this pesticide.

The preparation of current single-agent formulations of propineb involves first synthesizing the technical-grade active ingredient, followed by formulation processing. The steps are as follows: (1) Synthesis of the technical-grade product, which involves two stages. The first stage uses 1,2-propylenediamine and CS₂ to synthesize propineb acid, which is then neutralized with a base to obtain ammonium propineb, sodium propineb, or potassium propineb. In the second stage, the salt reacts with a zinc salt to form propineb. The salts produced in the first step are water-soluble and can dissolve in water to undergo metal ion exchange with zinc salt, yielding propineb as a precipitate in block or granular form. This precipitate is insoluble in both water and organic solvents and requires separation, washing, and drying to obtain technical-grade propineb. (2) Formulation processing: using solid technical propineb as raw material, the formulation process includes crushing, grinding, and mixing to obtain the final propineb product. The entire process, from water-soluble intermediate salts to solid propineb formulations, requires corresponding production equipment and workshop facilities—such as filters, dryers, crushers, grinders, and mixers—as well as complete processing workflows. It is evident that converting water-soluble intermediates into solid propineb products is both lengthy and energy-intensive.

Existing technology: Chinese patent CN201711490378.4, titled “Preparation Method for Nano Mancozeb,” discloses a nanoparticle powder formulation of mancozeb.

The conventional process for preparing technical-grade mancozeb and converting it into a wettable powder formulation is shown in FIG. 1.

### DISCLOSURE OF THE INVENTION

Prior application: PCT/CN2022/139831

One of the objectives of the above invention is to overcome the shortcomings of existing technologies by providing a new approach and method different from the conventional powder formulation of mancozeb. Through the process of water dilution, a reaction is triggered between ammonium mancozeb (or sodium mancozeb or potassium mancozeb) and manganese and zinc salts, resulting in the formation of mancozeb, thereby producing an apparently water-soluble, visually transparent mancozeb nanosuspension that can be directly used for spraying.

The mancozeb nanosuspension described in the above invention can be loaded into pesticide spraying equipment and used directly for field application.

The innovative concept of the present invention is as follows:

Ammonium propineb, sodium propineb, or potassium propineb is a water-soluble ammonium salt, which exists as monomolecular species dispersed in water and serves as one component. The zinc salt that reacts with it also exists as monomolecular ions in water and serves as the other component. When these two components meet, the formation of the propineb structure is very easy. Since zinc ions are multivalent metal ions, in addition to forming conventional salts, the resulting propineb may actually be a coordination compound. Because it is an ionic reaction, the reaction proceeds rapidly. By controlling the addition rate of one component and the stirring speed during mixing, it is possible to obtain nano-sized propineb crystals.

Under controlled stirring conditions, one aqueous solution (e.g., zinc salt) is added to another aqueous solution (e.g., ammonium propineb). By controlling the drip rate and stirring speed, nano-sized propineb crystals can be formed, resulting in a propineb nanosuspension.

When the resulting nano propineb crystals are very small and sparse, they can remain temporarily stable in water. As more nano propineb particles are generated, collisions, growth, and aggregation among them will begin to occur. Once the particle size approaches or exceeds the wavelength of visible light, the system will begin to exhibit opalescence and gradually lose transparency. In addition, due to gravity, larger particles will settle out. To prevent this phenomenon, the system must include polymeric additives. These are water-soluble polymers, typically non-crystalline macromolecules that form random coil structures in water. The random coils are loose spherical structures formed by the spontaneous curling of polymer chains, with hydrophobic main chains aggregated inside and polar hydrophilic groups exposed on the outside. When propineb nanoparticles generated in the system are smaller than 100 nanometers, they can be dispersed into the interior of the random coils under the shear force of mechanical stirring. This physical encapsulation prevents further effective collisions, crystal growth, and sedimentation. Thus, the random coils formed by water-soluble polymeric additives provide dispersing, suspending, stabilizing, and protective functions for the nano propineb particles. Since the random coils are uniformly dispersed in the aqueous phase, the propineb nanoparticles embedded within them are also uniformly dispersed in water. When the particle size is below 100 nanometers, natural light passing through the solution will not experience significant reflection or refraction, and the system appears clear, transparent, and apparently water-soluble.

It should be noted that in the process of generating nanopesticide particles, the dripping speed of one component into the other and the stirring speed of the aqueous polymer solution are key factors influencing the amount of reactants added per unit time and the degree of product dispersion—both of which are critical for controlling the size of the resulting nanoparticles. For dripping speed, if the target is to produce nanopesticide particles with a diameter less than 100 nanometers, the visual clarity of the system becomes the criterion. The theoretical basis is that when particle size is less than one-quarter the wavelength of visible light, no significant scattering or reflection occurs, and the system appears transparent. The visible light wavelength range is 400-760 nm, so one-quarter of that is below 100 nm. Conversely, if the nanosuspension appears clear, it indicates that the particles are indeed below 100 nm.

To achieve this objective, the following points must be considered:
\textcircled{1} the mixing speed of the two solutions (i.e., the addition speed of one component) must not be too fast. If the addition is too fast, the components are not evenly dispersed, local concentrations may become too high, and the rapid formation of particles may lead to aggregation, increasing particle size. If the system shows opalescence, it indicates that particle size has reached several hundred nanometers. Increasing opacity indicates that particle size has approached or exceeded one micron. Therefore, the addition speed should be controlled such that the system remains transparent throughout.
\textcircled{2} the stirring speed of the system should be appropriately increased. Stirring affects both the formation and dispersion rate of nano propineb particles in water. Proper stirring promotes better dispersion, aids in the rapid formation and stabilization of smaller particles, and prevents aggregation. Only in this way can small and uniform propineb nanoparticles be obtained. Once the addition of both solutions is complete, stirring should continue briefly to ensure the full dispersion, suspension, and stabilization of the nano propineb particles in the water-soluble polymeric additive solution.

### Terminology Explanation

Tyndall effect: The so-called Tyndall effect refers to a phenomenon in which, when a beam of light passes through a colloid, a bright “path” of light can be observed in the colloid from a direction perpendicular to the incident light. This phenomenon is also known as the Tyndall phenomenon (Tyndall effect). The essence of the Tyndall effect is a scattering phenomenon that occurs when light propagates through a colloid. This occurs mainly because the particle size of colloidal particles is between 1-100 nm, and visible light produces significant scattering when passing through the colloid, while the scattering effect of true solutions is very weak. Therefore, colloids exhibit a pronounced Tyndall effect, whereas molecularly dispersed true solutions exhibit almost none. Hence, the Tyndall effect is often used to distinguish colloidal solutions from true solutions.

A further explanation of the Tyndall effect is that when light propagates and encounters particles in the solution, if the particle size is larger than the wavelength of incident light (400-740 nm) or many times larger, pronounced reflection of light occurs. If the particle size is smaller than the incident light's wavelength, light scattering occurs, which can be observed as light waves surrounding the microparticles and radiating in all directions. This radial light is called scattered light or opalescence. The essence of the Tyndall effect is thus light scattering or opalescence. Since the particle radius in true solutions generally does not exceed 1 nm, and colloidal particles fall between solute particles in true solutions and particles in suspensions, with sizes between 1-100 nm—less than one-quarter the lower limit of visible light wavelengths—scattering occurs noticeably when visible light passes through a colloid. For true solutions, the molecules or ions are even smaller, and the intensity of scattered light decreases significantly as particle volume decreases. Therefore, light scattering in true solutions is negligible. Additionally, the intensity of scattered light increases with rising particle concentration in the dispersion system. Based on this, it can be determined: when a solution appears clear and transparent, the particle size is less than 100 nm and the Tyndall effect may occur; if the solution appears opalescent or increasingly opalescent, the particle size exceeds 100 nm and tends to grow larger; if the solution becomes turbid or opaque, the particle size has increased to the micron level or more.

System: The term “system” refers to the suspension system formed by mixing two components under controlled addition rate and stirring conditions during the preparation of the propineb nanosuspension of the present invention. The system consists of water, precursor, zinc salt, and water-soluble polymeric additives mixed to generate the target product—nanosuspension.

Component: A component refers to a composition containing one or more ingredients. In principle, any ingredient used in this invention can form an individual component. However, for the convenience of packaging, transport, and use, it is preferable to combine and simplify ingredients into fewer components, following these principles: \textcircled{1} no chemical reactions occur between the ingredients; \textcircled{2} the number of resulting components should not be excessive.

Ingredient: Ingredients refer to the raw materials used in this invention, including water-soluble propineb salts, zinc salts, water-soluble polymeric additives, and water.

Precursor: A precursor refers to the mother substance used for generating the final product, i.e., the water-soluble propineb salts including ammonium propineb, sodium propineb, and potassium propineb.

Water-soluble polymeric additive: This refers to a polymer substance containing hydrophilic polar groups that can dissolve in water. Also referred to as a polymeric surfactant or active agent. Water-soluble polymeric additives function to disperse, suspend, emulsify, and stabilize the system. Based on the nature of the functional groups, these can be classified as anionic, cationic, amphoteric, or non-ionic polymeric additives.

Particle size: Also referred to as particle diameter; it refers to the size of the propineb crystal particles formed in the system through interaction between the precursor and zinc salt under dispersion by the water-soluble polymeric additive. It also includes the particle size of other pesticide compounds used in combination. It does not specifically refer to the microstructure of the crystals.

Sub-100 nm level: This is a statistical classification of the particle size of pesticide particles in the system. All particles in the suspension follow a statistical distribution. The sub-100 nm nanosuspension mentioned in this invention refers to a formulation where the peak value on the particle size distribution curve (mass fraction vs. particle size) for each sub-group is below 100 nm. It can be measured using a Malvern laser nanoparticle size analyzer from the UK, and processed using the Number statistical method.

Stability period: Refers to the time the nanosuspension can maintain a transparent state after preparation. To ensure the completion of spraying operations, the stability period should not be less than one hour. The “hour-level stability period” proposed in this invention refers to a stability duration between 1 to 10 hours.

Effective stirring rate: This refers to the minimum stirring speed required—under a given addition method—when one component is added to another, to allow timely dispersion of the generated nanoparticles in the system, preventing particle growth and aggregation and keeping particle sizes below several hundred nanometers. A transparent appearance of the system's liquid indicates effective stirring.

Effective stirring: The method and speed of adding components and stirring significantly impact the resulting suspension. Stirring methods include mechanical stirring, multi-point mechanical stirring, manual stirring, and multi-point manual stirring. Faster stirring speeds generally yield better results. If the generated liquid appears transparent, the stirring is considered effective; otherwise, it is ineffective.

Addition method: This includes adding component A to component B, component B to component A, or simultaneously adding both components into the system. It also encompasses continuous addition, intermittent addition, thin-stream addition, dropwise addition, spray addition, and fixed-position or moving-position addition. The optimal addition method ensures rapid mixing and dispersion of both components.

Addition rate: After the addition method is determined, the addition rate should be controlled to achieve effective stirring.

Nanoemulsion: Also referred to as nanoemulsified formulation. This refers to a dispersed system in which the active ingredient of the pesticide forms a solution that, under the action of dispersing agents in water, produces emulsion particles of nanoscale size. Nanoemulsions appear clear and transparent, typically having a particle size below 100 nm and exhibiting thermodynamic stability.

One of the objectives of the present invention is to overcome the limitations of existing technologies by providing a new approach and method. It utilizes the conventional dilution process—where water is used as the dispersing medium during agricultural spraying—to achieve the mixing and reaction of ammonium propineb (or sodium propineb, potassium propineb) and a zinc salt (such as zinc sulfate), thereby generating propineb zinc. The invention thus provides a water-dilutable, transparent-appearing propineb zinc nanosuspension suitable for direct application using agricultural spraying equipment.

The propineb zinc nanosuspension of the present invention can be loaded directly into pesticide sprayers for application. It is primarily intended for controlling the following diseases: downy mildew, black rot, anthracnose, and grey mold in grapes; apple and pear scab and brown rot; leaf spot in stone fruits; tomato wilt, phytophthora blight, downy mildew, septoria leaf spot, and leaf mold; potato wilt and phytophthora blight; tobacco downy mildew; rust and leaf spot in ornamental plants; and rust, leaf spot, and downy mildew in vegetables. It can also be used on citrus fruits, berry trees, tea plants, and rice. When used at recommended dosages, it is safe for crops, including those in sensitive growth stages.

The propineb zinc nanosuspension described in this invention refers to a formulation where the majority of particles fall below the 100-nanometer scale. This nanosuspension is formed by diluting and mixing at least two components with water:
Component A: A water-soluble propineb salt or aqueous solution thereof, along with a water-soluble polymeric additive. The water-soluble propineb salt can be ammonium propineb, sodium propineb, potassium propineb, or a mixture of at least two of them;
Component B: A zinc salt or aqueous solution of a zinc salt at a defined mass ratio;
Component B may additionally contain a water-soluble polymeric additive to form a solution.

The water-soluble polymeric additive used is a nonionic surfactant.

The ratio of water-soluble polymeric additive to diluting water should not exceed 1:1500; preferably, not more than 1:1200; and more preferably, not more than 1:1000.

Preferred nonionic surfactants include: water-soluble starch and its derivatives, water-soluble guar gum and its derivatives, polyoxypropylene-polyoxyethylene block copolymers, alkylaryl polyoxypropylene-polyoxyethylene ethers, fatty alcohol polyoxyethylene ethers, fatty acid polyoxyethylene ethers, fatty amine polyoxyethylene ethers, castor oil polyoxyethylene ethers, Tween (polysorbates), alkyl polyglycosides, polyvinyl alcohol, and polyvinylpyrrolidone. Among these, preferred examples are polyoxypropylene-polyoxyethylene block copolymers, alkylaryl polyoxypropylene-polyoxyethylene ethers, OP-10, fatty alcohol polyoxyethylene ethers, fatty acid polyoxyethylene ethers, castor oil polyoxyethylene ethers, Tween, and alkyl polyglycosides.

The zinc salt is selected from at least one of the following: zinc sulfate, zinc acetate, zinc chloride, and zinc nitrate.

Furthermore, the sub-100 nm propineb zinc nanosuspension of the present invention exhibits an hour-level stability period.

When the propineb salt and zinc salt used are ammonium propineb and zinc sulfate, respectively, considering that ammonium propineb has two acidic groups and zinc ions are divalent with tetracoordinate activity, the molar ratio range is defined as follows:

$$Ammonium propineb : Zinc sulfate = 1 : 0.5 - 1.01$$

$$Preferably , ammonium propineb : Zinc sulfate = 1 : 0.9 - 1. .$$

In industrial production, a molar ratio of 1:1.01 is adopted to ensure complete reaction of ammonium propineb by using a slight excess of zinc sulfate.

The multivalent nature of zinc ions is responsible for the resulting propineb zinc product's insolubility in both water and organic solvents, acting similarly to a crosslinking agent. In the present invention, the reaction between ammonium propineb and zinc sulfate is completed during the water-dilution step. An excess of zinc ions is unfavorable for the dispersion and stability of the resulting propineb zinc nanoparticles; therefore, the molar ratio of zinc sulfate is preferably close to or equal to 1.

To reduce packaging and transportation costs of the formulation, the specifications of each component can be either identical or different. When using zinc salt solution as component B, a certain amount of water-soluble polymeric additive may be added, provided that the resulting solution remains clear (i.e., without turbidity), typically at a concentration not exceeding 10%.

### Sub-100 nm Propineb Zinc Nanosuspension

To enhance the bioefficacy of nanoscale propineb zinc, the present invention aims to reduce its particle size as much as possible. The original intention behind developing nano-pesticides is to improve pesticide efficacy and reduce the required dosage. Conventional pesticide formulations typically have particle sizes in the micrometer range. Reducing these to nanoscale levels spans three orders of magnitude, and the increase in the number of particles varies accordingly. For example, reducing the particle size of a conventional formulation from 2 μm to 200 nm, 20 nm, and 2 nm theoretically increases the number of particles by 10³, 10⁶, and 10⁹ times, respectively. Therefore, different levels of size reduction result in different levels of increase in particle count, which in turn leads to different levels of efficacy. For this reason, to maximize the bioefficacy of nano-pesticides, the particle size should be minimized as much as possible.

To further enhance the bioefficacy of nanoscale propineb zinc, the present invention aims to reduce the particle size to below 100 nm. This is based on two considerations: (1) 100 nm is the upper limit of at least one dimension in the standard definition of nanomaterials; and (2) when pesticide particles are within the range of 1-100 nm, the formulation belongs to the category of colloidal solutions, appearing water-dilutable and transparent. When a light beam passes through the solution, a clearly defined light path is visible, consistent with the description of the Tyndall effect.

### Suspension Concentration

In low-concentration suspensions, the proportion of particles smaller than 100 nm is relatively higher, and transparency is not significantly affected. In systems using 1,500 g/ha of propineb zinc diluted in more than 50 kg of water, this applies.

In high-concentration suspensions, the proportion of sub-100 nm particles is lower, which has a more significant impact on transparency. For example, in systems using 1,500 g/ha of propineb zinc diluted in only 20 kg of water, transparency may still be temporarily observed. However, due to high concentration, particles are more prone to collisions, crystal growth, and aggregation, which significantly affects the stability of the transparent appearance.

Dilution volumes between 20 and 50 kg represent the transitional range of suspension concentrations.

### Stability Period

The propineb zinc nanosuspension developed in this invention is a formulation with transparent appearance and apparent water-dilutability, but it is not thermodynamically stable. Therefore, the transparent state of the nanosuspension does not last indefinitely and is subject to a defined stability period. Given the operational requirements of spraying, the transparent state must persist for at least 1 hour after preparation to allow sufficient time for field application. Thus, the present invention introduces the concept of a stability period for sub-100 nm nanoscale propineb zinc suspensions. That is, the suspension should retain its transparency for at least 1 hour to ensure completion of the spraying task.

From an application perspective, the stability period can be further categorized into four-time intervals: within 1 hour, 1-5 hours, 5-10 hours, and more than 10 hours.

If spraying can be completed within 1 hour, the nanosuspension remains transparent, indicating that the particle size is still below 100 nm.

Changes in transparency and particle size during the stability period can be monitored visually. During the stability period, the suspension remains clear, indicating particle sizes below 100 nm. When instability begins, the suspension shows opalescence, indicating initial particle growth. A faint opalescence suggests that particle size has started to exceed 100 nm; more intense opalescence indicates growth to several hundred nanometers; a turbid or opaque appearance suggests particle sizes have reached the micron level or above. If crystallization or sedimentation occurs, particle sizes have reached millimeter scale.

The visual assessment of the stability period described in this invention for sub-100 nm nanoscale propineb zinc suspensions applies to all hour-level stability categories.

### Hour-Level Stability Period

From the perspective of spraying operations:

A stability period of around 1 hour provides limited time for application; whereas a period exceeding 10 hours offers little additional benefit for pesticide formulations. Even if the spray solution is highly stable, the typically low active ingredient content and large volume make it unsuitable for storage and transport.

Therefore, a stability period between 1 and 10 hours allows most pesticide spraying operations to be completed comfortably within this timeframe.

The hour-level stability period described in this invention refers specifically to a transparency-stable duration within the range of 1 to 10 hours.

This hour-level stability period can be further subdivided:
1 to 5 hours is defined as the basic period for spraying operations; in most cases, spraying equipment can complete the application within this timeframe.
5 to 10 hours is defined as the extended period for spraying operations; this accommodates any special circumstances that might delay the operation.

### Components and Adjuvants of Propineb Nanosuspension

Conventional single-agent and binary mixture formulations of propineb typically consist of a single component, which can be directly diluted with water for spraying. However, the particle sizes of most conventional pesticides are larger than the micrometer scale. To obtain a nanoscale propineb suspension, the present invention adopts a multi-component system—consisting of at least two components—that is diluted with water following a specific method to produce a propineb nanosuspension with particle sizes below 100 nm.

A three-component model is described below as an example.

### Basic Three-Component Scheme

The nanosuspension with particle sizes below 100 nm described in the present invention is generated from a system formed by mixing and reacting three components:

Component A: composed of solid or aqueous solutions of ammonium propineb, sodium propineb, or potassium propineb; this serves as the precursor for forming propineb nanocrystals.

Component A may be a single salt or a mixture of two or three of them. These can be used as solids—offering convenient packaging and small volume, which can be quickly dissolved in water before use—or as aqueous solutions to be diluted directly before application.

Component B: composed of solid zinc salts or their aqueous solutions in a defined ratio; this provides the multivalent metal ions necessary for forming the propineb nanocrystals.

The zinc salt is selected from at least one of the following: zinc sulfate, zinc acetate, zinc chloride, or zinc nitrate. Component B may be used in solid form for compact packaging, or as an aqueous solution, though its concentration will be limited by solubility and requires appropriate container volume.

Component C: composed of at least one surfactant or its aqueous solution; this functions as the adjuvant responsible for dispersing, suspending, and stabilizing the generated propineb nanocrystals.

Component C is a water-soluble surfactant-based adjuvant. The adjuvant serves to disperse, suspend, and stabilize the propineb nanocrystals formed in the system. The surfactant may be selected from polymeric or small-molecule types. Considering that polymeric surfactants provide better dispersion, suspension, and stabilization effects compared to small-molecule surfactants, the invention preferably uses polymeric surfactants.

The preferred mass ratio of the water-soluble surfactant to the dilution water is not greater than 1:1000.

In terms of surfactant type, common anionic surfactants are usually monovalent metal salts or ammonium salts. When these anionic surfactants encounter multivalent metal ions in aqueous solutions, they may be displaced and precipitate due to loss of solubility. Therefore, the present invention adopts nonionic surfactants as water-soluble polymeric adjuvants to disperse, suspend, and stabilize the propineb nanocrystals.

The water-soluble polymeric adjuvants of the present invention are selected from nonionic surfactants. Preferred examples include: derivatives of polyoxyethylene polymers, such as polyoxyethylene-polyoxypropylene block copolymers, fatty alcohol polyoxyethylene ethers, fatty acid polyoxyethylene ethers, fatty amine polyoxyethylene ethers, and plant oil polyoxyethylene ethers; Natural product derivatives, such as water-soluble starch, cellulose, nonionic derivatives of chitosan, dextrins, methyl ethyl cellulose, etc.; Polyhydric alcohol derivatives, such as Tween surfactants, alkyl polyglycosides, etc.; Synthetic polymer products such as polyvinyl alcohol and polyvinylpyrrolidone. The water-soluble polymeric adjuvants described in this invention may be any one or more of the above nonionic surfactants.

To simplify the component system and facilitate packaging, storage, transport, and aqueous dilution during application, the above three-component system can be merged into a two-component system.

### Improved Two-Component Formulation

One of the improvements proposed by the present invention is a two-component system for generating a propineb nanosuspension with particle sizes below 100 nm, exhibiting an hour-level stability period. These components are:

Component A: an aqueous solution composed of ammonium propineb (or sodium propineb, potassium propineb), water-soluble polymeric adjuvants, and water. This contains the precursor for forming propineb nanocrystals and the water-soluble polymeric nonionic surfactant responsible for dispersion, suspension, and stabilization.

Component B: an aqueous solution composed of a zinc salt, water-soluble polymeric adjuvants, and water in a defined proportion. The zinc salt is selected from zinc sulfate, zinc acetate, zinc chloride, or zinc nitrate.

Since the solubility of zinc salts in water is limited, to minimize the volume of Component B, the water content must be restricted. Moreover, the amount of adjuvant added to Component B is also limited due to its influence on the solubility and volume, hence placing an upper bound on the adjuvant-to-water ratio in Component B—unless no constraints on volume are assumed.

This improvement lies in the distribution of water-soluble polymeric adjuvants between Component A and Component B. Considering the limitations of Component B, most of the adjuvant content is assigned to Component A.

### Component Proportions for Generating Propineb

The two-component formulation described above includes:

Component A: composed of ammonium propineb (or sodium propineb, potassium propineb) or their aqueous solution, with the addition of adjuvants.

Component B: zinc sulfate (or zinc acetate, zinc chloride, zinc nitrate) dissolved in water in a defined proportion, with optional addition of adjuvants.

The amount of active ingredient in each component determines the composition. The content of ammonium propineb in Component A, as the precursor for propineb nanocrystals, determines the required composition of Component B.

As an example: Assume 100 grams of propineb are required to be sprayed over 1/15 hectare of farmland. The formulation is designed to generate 100 g of sub-100 nm propineb nanosuspension using two components.

Component A: uses approximately 90 g of ammonium propineb as the precursor. Based on the adjuvant distribution principles, most of the adjuvants are allocated to Component A. Assuming both Component A and Component B are packaged in 500 g units, the remaining portion after accounting for the ammonium propineb and adjuvants is water.

Component B: the amount of inorganic zinc salt required to react with ammonium propineb is first determined. Zinc sulfate is preferred in this invention. It is generally considered that zinc ions displace ammonium ions to form the salt, possibly yielding a linear repetitive structure or a coordination complex, as zinc ions can exhibit tetracoordination.

According to literature, the molar ratio between ammonium propineb and zinc ions in the synthesis of propineb typically ranges from 1:1.00 to 1.05. Given that ammonium propineb contains two acidic ammonium groups and zinc ions are divalent, the theoretical molar ratio is 1:1, with slight excess zinc sulfate added to ensure full reaction. Although zinc ions can also coordinate in a tetravalent manner, elemental analysis of propineb samples shows a zinc content close to the theoretical 22.8%, indicating that ammonium propineb (propylenebis (dithiocarbamate)) and zinc sulfate combine in a 1:1 molar ratio.

In this invention, to generate 100 g of propineb, 90 g of ammonium propineb is used (0.346 mol). For a 1:1 molar ratio, the corresponding amount of anhydrous zinc sulfate would be 56.5 g, though a slightly lower mass may also be applied.

### Distribution of Adjuvants Between Component A and Component B

Component A primarily contains ammonium propineb (or sodium propineb, potassium propineb).

It is necessary to separately package Components A and B because they will react upon mixing. In a two-component system, adjuvants must be added to Component A; otherwise, there would be nowhere to incorporate them unless a separate adjuvant solution is introduced as a dedicated third component, which would complicate packaging and dilution processes.

Adjuvants can be added to Component A under the condition that both ammonium propineb and the adjuvants are water-soluble and compatible—i.e., no precipitation or instability occurs. However, due to the relatively high content and viscosity of ammonium propineb and the adjuvants, the mixture is difficult to handle. Therefore, a certain amount of water must be added to dilute the mixture, reducing viscosity and improving the ease of handling and dilution. Once this objective is met, the overall mass of Component A should be minimized to reduce manufacturing, packaging, and transportation costs.

Component B primarily contains zinc salts or their aqueous solutions.

Component B can be supplied as a solid zinc salt, to be dissolved in water prior to use. For convenience, it can also be supplied as an aqueous solution. Given the limited solubility of zinc salts, a certain amount of water is required. Adjuvants may be added or omitted from Component B for two reasons: If too much adjuvant is added to Component B, a film may form on the surface of the zinc salt-adjuvant-water solution, hindering subsequent dilution. If Component A contains a sufficient amount of adjuvant to ensure the dispersion and suspension of the resulting propineb nanocrystals, then adjuvants may be omitted from Component B.

However, if the propineb formulation is intended for use in orchards—where tree canopies are large and the spray solution volume can exceed 200 kg per mu—then the dilution water volume is very large. In such cases, if the adjuvant content in Component A is insufficient to disperse and suspend the generated nanocrystals in the diluted solution, then it becomes necessary to add an appropriate amount of adjuvant to Component B to compensate for the deficiency.

It is important that the amount of adjuvant added to the zinc salt solution in Component B maintains the solution's transparency and avoids surface film formation during storage. The typical mass concentration of adjuvant added to Component B should not exceed 10%.

Although the challenges described above could be addressed by increasing the overall mass of Components A and B, this would undoubtedly increase manufacturing, packaging, and transportation costs. Therefore, under the premise of producing a unit mass of propineb, it is crucial to balance the quantities and specifications of other formulation components (e.g., adjuvants and water), aiming to minimize the total mass and volume as a key consideration in product design.

### Water-Soluble Polymeric Adjuvant

1. The transparent liquid prepared by mixing Propineb zinc is a directly usable nanosuspension dispersion. In this formulation, the Propineb zinc is suspended and dispersed in the aqueous polymeric adjuvant at nanoscale dimensions. Since the particle size is smaller than 100 nanometers, the resulting suspension appears visually transparent and behaves as an apparently water-soluble nanosuspension of Propineb zinc.
2. The water-soluble polymeric adjuvant with dispersing capability is a crucial component that determines the particle size of the Propineb zinc nanocrystals generated through the mixing of the two components, and whether these can be uniformly dispersed and stably suspended.
3. Polymeric adjuvants are also polymeric surfactants, typically referring to substances with molecular weights above 10,000 that exhibit surface activity. Compared with small-molecule surfactants, polymeric surfactants are less effective at reducing surface tension but provide unique properties such as dispersion, suspension, and viscosity enhancement. According to their source, they can be classified into natural polymers and their derivatives, and synthetic polymers. Polymeric surfactants contain hydrophobic chains and hydrophilic functional groups, such as hydroxyl, carboxyl, carboxymethyl, sulfonic acid, sulfuric acid, phosphoric acid, amino groups, etc., located on the end or side chains, thus qualifying as water-soluble polymers.
   Natural water-soluble polymers and their derivatives include starch (amylose), dextrin, and its derivatives such as water-soluble starch, oxidized starch, carboxymethyl starch, modified starch, cellulose and its derivatives (carboxymethyl cellulose, hydroxyethyl hydroxypropyl cellulose), carboxymethyl chitosan, modified guar gum, tea saponin, water-soluble humic acid, sodium lignosulfonate, etc. Synthetic water-soluble polymers include polyvinyl alcohol (PVA), polyacrylic acid, polyacrylamide, styrene-maleic anhydride copolymer, polyvinylpyrrolidone (PVP), etc. Since synthetic polymers typically have carbon-based backbones that are not readily biodegradable, environmentally friendly considerations favor the use of natural water-soluble polymers and their derivatives to minimize ecological impact.
4. This invention selects polymeric adjuvants specifically for their dispersing and suspending capabilities in aqueous media. Water-soluble polymers with molecular weights ranging from tens of thousands to several hundred thousand typically exist as linear polymer chains that dissolve in water. Upon dissolution, due to the flexibility of the molecular chains, they form coiled structures known as “random coils” rather than remaining fully extended. The hydrophilic groups orient toward the aqueous phase, while the hydrophobic chains curl inward.
   The size of a random coil depends on molecular weight, concentration, and chain structure. Higher molecular weights and flexible chains lead to larger random coils. At high concentrations, different polymer molecules may aggregate, increasing overall volume. Random coils typically range from tens to hundreds of nanometers in diameter. When pesticide nanocrystals are generated, hydrophobic nanocrystals tend to embed themselves in the hydrophobic interiors of random coils based on the principle of like-dissolves-like. The smaller the particle, the more easily it can be dispersed within these coils. Thus, water-soluble polymeric adjuvants play a vital role in stabilizing and dispersing the resulting nanoparticles.
   Traditional pesticide suspensions also rely on this mechanism, but their micro-sized particles result in opacity and limited suspension stability due to gravitational settling. When particle sizes are reduced by 2-3 orders of magnitude, gravitational effects are greatly diminished, and the same polymeric surfactants can yield much more stable and transparent suspensions.
5. Water-soluble polymeric adjuvants, like small-molecule surfactants, can be classified based on the nature of their functional groups into anionic, cationic, amphoteric, and nonionic types. Anionic adjuvants carry acidic groups such as carboxylic, sulfonic, or sulfuric acids and usually exist as monovalent metal salts. Examples include carboxymethyl starch, carboxymethyl cellulose, lignosulfonates, humate salts, polyacrylic acid, styrene-maleic acid salts, etc. Cationic adjuvants contain basic groups or salts formed with acidic groups, such as chitosan hydrochloride, polyacrylamide, or quaternized pyridine groups. Amphoteric adjuvants include both anionic and cationic groups in one molecule, such as carboxymethyl chitosan and carboxymethyl cellulose. Nonionic adjuvants include polyoxyethylene-polyoxypropylene-polyoxyethylene block copolymers and various polyoxyethylene ethers derived from fatty alcohols, fatty acids, fatty amines, alkylphenols, arylphenols, oils, and other hydrophobes, such as the Peregal series, OP series, Tween series, polyol series, ricinoleic acid series, and alkyl polyglycosides.
6. The first three categories (anionic, cationic, amphoteric) contain reactive acidic or basic groups that can interfere with the formation of Propineb zinc during the reaction between Propineb ammonium and zinc sulfate. Anionic adjuvants tend to precipitate with zinc ions, while cationic adjuvants may react with Propineb ammonium. Therefore, these types are not suitable for use in this invention.
7. Only nonionic polymeric adjuvants can be used in this invention. The hydrophilic groups of these adjuvants—mainly polyoxyethylene ethers—form random coils or “micelles.” Their hydrophilic exterior and hydrophobic interior allow Propineb zinc nanocrystals to embed inside, enabling effective dispersion and stabilization.
8. The nanosuspension of Propineb zinc is formed in situ during the water dilution step, via reaction between the Propineb precursor (ammonium, sodium, or potassium salt) and zinc salt. Since the effective ingredient concentration is already at application level—around 0.5-1.0 g per kg of water (e.g., 100 g/15-acre unit, diluted with 100-200 kg of water per mu, 1 mu= 1/15 hectare)—the amount of polymeric adjuvant can be adjusted to ensure sufficient suspension stability.
   The required amount of polymeric adjuvant depends on the amount of Propineb zinc formed and the water volume used for dilution. For example, if 100 g of Propineb zinc is applied per mu, with 100, 150, or 200 kg of dilution water, the active concentration would be 0.100%, 0.067%, or 0.05%, respectively. The polymeric adjuvant concentration should be in the 0.1%-0.5% range.
   Particle size analysis confirms that the active ingredient in the nanosuspension is in the range of 10-60 nm. This nanosuspension remains stable for up to 8 hours without precipitation and can be directly used in various pesticide sprayers.
9. The Propineb zinc nanosuspension described herein is formed directly during the pre-application water dilution process. The water-soluble Propineb salt and polymeric adjuvant constitute Component A, while a zinc salt solution (with or without dispersant) forms Component B. Upon mixing at specified concentrations and conditions, the desired nanosuspension is obtained. This approach eliminates the need for upstream Propineb zinc synthesis and purification at the active ingredient factory, as well as downstream formulation steps such as milling into wettable powders. This method is energy-saving, environmentally friendly, and cost-efficient, yielding a Propineb zinc nanosuspension with particle size below 100 nm. The significantly smaller particle size enhances bioavailability and efficacy, enabling reduced pesticide usage and improved effectiveness.

A flowchart for preparing the nanosuspension via water dilution is shown in FIG. 2.

### Key Technical Features of the Invention

### 1. Generation Process of the Nanopesticide

This invention innovatively proposes a new model and method for preparing nanosuspensions of pesticides containing multivalent metal ions, which are insoluble in water and organic solvents. By leveraging the water dilution process normally required for pesticide application, the precursor of the target compound is mixed with the corresponding metal salt. Through controlled mixing and stirring, and using the principle of rapid reaction of metal ions, a directly usable nanosuspension with particle size less than 100 nanometers can be obtained. This method eliminates the need for the technical synthesis and purification of Propineb zinc from Propineb ammonium (or sodium, or potassium) at the active ingredient production stage, as well as the multi-step physical processing required to formulate Propineb zinc into wettable powder at the formulation stage. This innovative conceptual approach, preparation model, and method form the most critical technical feature of the invention. It applies not only to Propineb zinc and its combinations with other fungicides but also to similar nanopesticide formulations of other pesticide compounds.

### 2. Concentration of Propineb Zinc

A key technique is controlling the concentration of Propineb zinc formed in water after mixing Component A (containing Propineb ammonium or sodium) and Component B (containing zinc salts). For example, if 100 g/15-acre of Propineb zinc is needed, the corresponding concentrations of Propineb ammonium (or sodium) and zinc sulfate should be adjusted based on dilution water volume. Propineb ammonium or sodium should be 0.09-0.045 g/kg, and zinc sulfate should be 0.07-0.0035 g/kg, with dilution volumes ranging from 100 to 200 kg. If the dilution volume is too low (e.g., <20 kg), particle size increases, transparency decreases, and stability worsens due to more frequent collisions between particles. On the other hand, if water volume exceeds 200 kg, transparency remains, but dispersant concentration drops significantly, reducing formulation stability. Thus, controlling the concentration of Propineb zinc—i.e., controlling dilution volume—is one of the critical steps to obtaining a nanosuspension with sub-100 nm particle size.

### 3. Type and Dosage of Dispersant

The selection and dosage of dispersants are another key technical factor. During the formation of Propineb zinc particles in water, merely using sufficient water and stirring is insufficient to keep the newly formed particles small. Due to constant Brownian motion and particle collisions, aggregation, crystal growth, and precipitation can occur. The effective way to inhibit growth is by selecting suitable water-soluble polymeric dispersants in proper dosage. These polymers exist in water as random coils, which are much larger than the newly formed Propineb zinc particles and can trap them inside, reducing collision frequency and improving stability.

However, not all water-soluble polymers are suitable. Experimental testing has shown that among various anionic, cationic, and nonionic surfactants, only certain nonionic polymeric adjuvants work effectively. Examples include polyoxyethylene ethers of fatty alcohols or fatty acids, polyoxypropylene-polyoxyethylene ethers of alkyl aryl groups, OP-10, alkyl polyglycosides, polyoxyethylene castor oil derivatives, and Tween-80. Only a few specific combinations yielded optimal results. Anionic surfactants are unsuitable because the multivalent zinc ions may displace sodium from the acid groups during the dilution reaction, causing co-precipitation with the Propineb zinc nanoparticles, defeating the purpose of dispersion. The invention does not exclude rare combinations of cationic surfactants with suitable anionic or nonionic types that remain stable and water-soluble.

The importance of using water-soluble polymeric adjuvants is self-evident. This invention relies on a water dilution process where water-soluble Propineb ammonium/sodium/potassium reacts with a zinc salt (e.g., zinc sulfate), forming a Propineb zinc suspension with particle size <100 nm. Without surfactants—particularly water-soluble polymeric ones—the resulting nanoparticles will collide, grow, aggregate, and eventually precipitate. When suitable types and dosages of water-soluble polymeric surfactants are used, the nanoparticles are stabilized within the random coils, improving dispersion, suspension, and stability.

The type and dosage of the adjuvant can be determined experimentally. The type is verified by stability tests under fixed conditions, either as a single polymer or in mixtures of two or more. This invention provides examples of these in the test section. Dosage is determined based on two conditions: (1) the resulting Propineb zinc nanosuspension must appear transparent, indicating particles <100 nm; and (2) it must remain stable for 1-10 hours, preferably at least 1-5 hours.

In a dual-component formulation, the adjuvant is distributed between Component A and Component B. Theoretically, without volume limits, any distribution is possible. However, in practical packaging scenarios (e.g., 500 g each of Component A and B for 100 g of Propineb zinc/15-acre application), Component B requires more water to dissolve the zinc salt and exhibits weaker solubility for adjuvants. Thus, the portion added to Component B is limited.

The distribution can be determined by:

$$Adjuvant dose ( Component A ) = Total adjuvant dose - Adjuvant dose ( Component B )$$

In fixed-volume systems, the upper limit of adjuvant in Component B is reached when the solution turns from clear to turbid after adjuvant addition.

All adjuvant dosage calculations refer to dilution water volume. Larger dilution volumes require proportionally more adjuvant. The adjuvant-to-water ratio should be ≤1:1200, preferably ≤1:1000.

### 4. Dosing Method

The dosing method is also one of the critical factors affecting the performance of the Propineb nanosuspension. Once the concentration of the active ingredient in the diluted solution is determined, the required amount of dilution water is effectively fixed. How this water is distributed—how much is used in Component A and Component B, and how the dilution process is carried out—will all influence the particle size and stability of the resulting Propineb nanosuspension.

For example, if the total water volume is 100 kilograms, two key questions arise:
(1) How should the water be allocated between the two components to form the diluted solutions of Component A and Component B?
(2) How should the components be added? Should the diluted Component A be added to diluted Component B, or vice versa?
These questions relate to the instantaneous concentration of reactants at the moment of mixing. For instance, if Component A is a diluted solution of Propineb ammonium, sodium, or potassium, whether or not it contains a dispersant—and if so, in what concentration—will directly affect the local concentration when the zinc salt solution of Component B is added to Component A. Additionally, the presence or absence of stirring at the time of mixing affects how well the newly formed product is dispersed.
The general principle is as follows: A higher concentration of dispersant in the precursor (substrate) component favors the dispersion and stabilization of nanoparticles; Stirring, especially effective and continuous stirring, enhances the dispersion and stability of nanoparticles.

### Preparation Method of Propineb Nanosuspension

The present invention adopts the following technical solution:

Under stirring conditions not less than the effective stirring speed, either Component A solution is added to Component B solution, or Component B solution is added to Component A solution, resulting in the formation of a Propineb nanosuspension.

The solutions of Component A and Component B are obtained by diluting the following with water:

Component A: Water-soluble Propineb salt or its aqueous solution, and an aqueous polymeric adjuvant. The water-soluble Propineb salt refers to Propineb ammonium, Propineb sodium, Propineb potassium, or a mixture of at least two of these.

Component B: A solid zinc salt or its aqueous solution, in a specified ratio.

By controlling the method of addition, the rate of addition, and the stirring speed, nanoscale Propineb particles with a size below 100 nm are formed in the suspension, resulting in a 100 nm-class Propineb nanosuspension.

### Effective Stirring Speed

The term “effective stirring speed” refers to the minimum stirring rate required such that, when one component is added to another under a given addition method and speed, the resulting nanoscale pesticide crystals are promptly dispersed in the mixture without significant aggregation. This prevents the particle size from growing to several hundred nanometers or even microns.

### Stirring Methods

Manual stirring: This is more suitable for most field applications. In this case, the stirring speed must be physiologically manageable and cannot be too fast.

Mechanical stirring: In agricultural fields, it is often difficult to use large containers equipped with stirring devices. If such equipment is available, the typical rotational speed is below 100 rpm. Stirring at approximately this speed is sufficient.

For manual stirring, the stirring speed should be consistent with normal human operation. To achieve a stable target product, the addition rate of materials may be appropriately reduced. The appearance of transparency in the resulting solution can be used as an indicator to determine the proper addition speed.

### Addition Method and Speed

To ensure that added materials are finely and uniformly dispersed upon entering the system, one component may be added to the other continuously, intermittently in portions, or dropwise. For dropwise addition, a manual sprayer—commonly used in rural areas—can be employed to spray the component into the system, which yields the best result. The addition speed should again be determined by observing the transparency of the solution being formed.

For traditional pesticide formulations applied using water as a dispersing medium, the common practice before spraying involves diluting the pesticide with water or premixing multiple pesticides—commonly referred to as “tank-mixing.” This invention leverages the “tank-mixing” process: Components A and B are mixed at specified concentrations, using controlled addition methods and speeds, and with the aid of a specific adjuvant—namely, a dispersant—to directly obtain a transparent Propineb nanosuspension suitable for on-site spraying.

### Dilution Water Volume

Current experimental data show that a starting range around 30 kilograms is relatively reasonable. Of course, this dilution water volume is strongly associated with the target stability period.

This is a multivariable issue; the adjuvants used in the components (composition and content) may also be influencing factors.

The objective of the present invention is to obtain a 100 nm-class Propineb nanosuspension with a transparent appearance and a stability period of 1 to 10 hours. When the mass of the precursor (e.g., 90 g of Propineb ammonium) and the corresponding metal salt (manganese sulfate, zinc sulfate) are fixed, other factors that influence nanoparticle size and stability include: dilution water volume, adjuvant dosage, and the preparation method.

The dilution water volume affects both the particle size of the resulting Propineb nanoparticles and the length of the stability period. This is because the quantity of water used as a dispersion medium affects the instantaneous concentration of Propineb ammonium and zinc sulfate solutions during their contact and reaction, as well as the uniformity of dispersion. These in turn influence the size of the particles formed, the quality of particle dispersion, and the likelihood of crystallization, agglomeration, and growth. The amount of adjuvant used also affects its concentration in solution under different water volumes, and thus its ability to disperse, suspend, and stabilize the resulting nanoparticles over a given period.

If the water volume is too small, a lower limit may be encountered. For example, when the dilution water volume is below 20 kg, the resulting transparent Propineb nanosuspension typically has a stability period of only about 1 hour, which is insufficient to ensure completion of spraying operations. Therefore, it becomes necessary to increase the dilution water volume.

In the present invention, to produce 100 grams of target product—i.e., a 100 nm-class Propineb nanosuspension with a transparency and a stability period of 1 to 10 hours—the selected dilution water volume ranges from 30 to 300 kilograms and is preferably between 50 and 200 kilograms.

### BRIEF DESCRIPTION OF THE DRAWINGS

FIG. 1: Process flow diagram for traditional Propineb synthesis and its formulation into wettable powder.

FIG. 2: Flow diagram for preparing Propineb nanosuspension (two-component method).

FIG. 3: Flow diagram for preparing Propineb nanosuspension (three-component method).

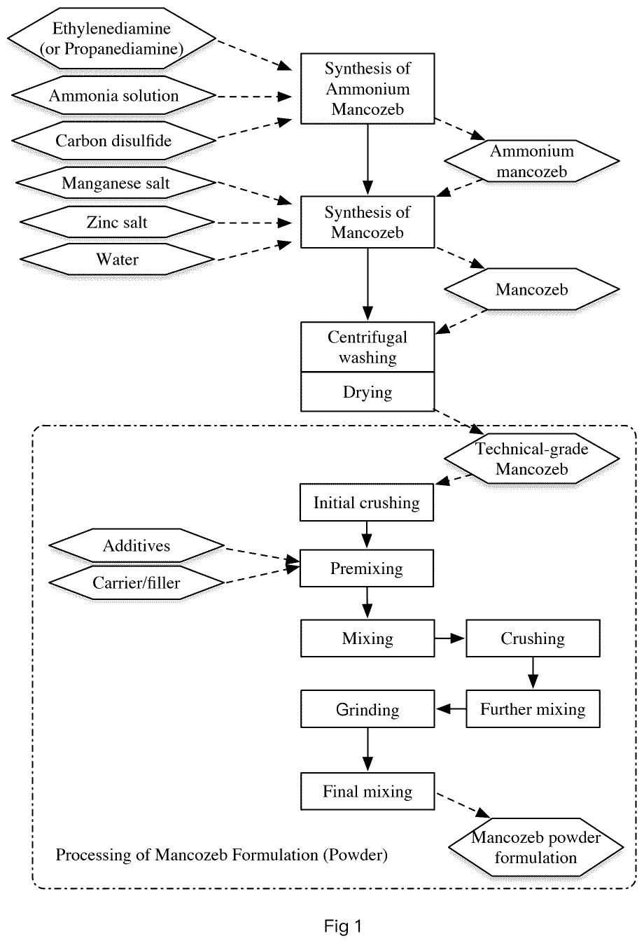

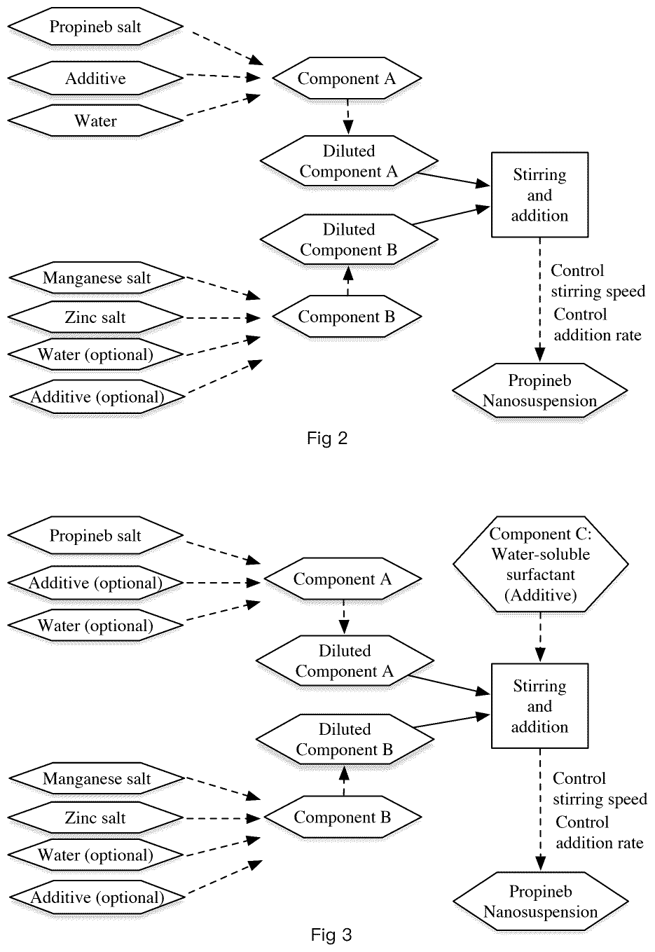

### EMBODIMENTS

The method for preparing a 100 nm-class transparent Propineb nanosuspension according to the present invention, using the two-component scheme, comprises the following operational steps:

Step 1: According to varying water quantities and dilution ratios, dilute Component A and Component B separately to obtain the diluted solutions of Component A and Component B.

Step 2: Under mechanical stirring (preferred) or manual stirring at a stirring speed not lower than the effective stirring speed, add the diluted Component A evenly into the diluted Component B, following a specified addition method (continuous or intermittent pouring, dropwise addition, spraying, etc.); or add in the reverse order.

The three-component scheme proceeds as follows:

Step 1: According to varying water quantities and dilution ratios, dilute Component A′ (or Component C) and Component B′ separately to obtain the diluted solutions of Component A′ (or Component C) and Component B′.

Step 2: Add Component C (or Component A′) into the diluted Component A′ (or Component C) solution, stir and disperse uniformly to form a mixed dilution of Component A′ and Component C.

Step 3: Under mechanical stirring (preferred) or manual stirring at a speed not lower than the effective stirring speed, add the diluted Component B′ evenly into the mixed dilution of Component A′ and Component C, using a specified addition method (continuous or intermittent pouring, dropwise addition, spraying, etc.); or add in reverse order.

### Embodiment 1

The Propineb nano-suspension is suitable for treating early and late blight in tomatoes and potatoes, as well as downy mildew in cucumbers. The effective ingredient dosage is approximately 100 grams per mu, and the typical dilution water volume is about 50 kilograms per mu. To produce 100 grams of propineb, 90 grams of ammonium propineb are required.

Component Ratios: The ratios of components, dilution water volume, water distribution, addition sequence and method, and test results are presented in the table below:

| | | | Dilution | Water | | | |
|---|---|---|---|---|---|---|---|
| | Composition | Total | Water | Distribution | Addition | Addition | |
| Component | (g) | (g) | (kg) | Ratio | Order | Method | Result |
| A | Ammonium | 400 | 50 | 2/3 and 1/3 | Add B | Continuous | Transparent |
| | propineb: 90 | | | | dilution | fine stream | propineb |
| | Additive: 210 | | | | into A | addition | nano- |
| | Water: 100 | | | | dilution | | suspension |
| B | Zinc sulfate: 55 | 55 | | | | | obtained; |
| | | | | | | | precipitation |
| | | | | | | | observed |
| | | | | | | | after 3 hours |

Additive Used: Alkylaryl polyoxypropylene polyoxyethylene ether/OP-10/Tween-80 (mass ratio 60:20:20)

### Operating Method:

Component A and Component B were separately diluted using 50 kilograms of dilution water in a 2:1 (2/3 and 1/3) ratio. Under stirring, the diluted solution of Component B was added into the diluted solution of Component A via continuous fine stream addition. A transparent propineb nano-suspension was obtained. Stability lasted for 3 hours.

### Embodiment 2

The propineb nano-suspension is suitable for controlling Marssonina blotch in apple trees. The effective ingredient dosage is 200 grams per mu, and the typical dilution water volume is approximately 200 kilograms per mu. To produce 200 grams of propineb, 180 grams of ammonium propineb are used.

Component Ratios: The ratios of components, dilution water volume, water distribution, addition sequence and method, and test results are presented in the table below:

| | | | Dilution | Water | | | |
|---|---|---|---|---|---|---|---|
| | Composition | Total | Water | Distribution | Addition | Addition | |
| Component | (g) | (g) | (kg) | Ratio | Order | Method | Result |
| A | Ammonium | 600 | 200 | 4/5 and 1/5 | Add B | Continuous | Transparent |
| | propineb: 180 | | | | dilution | spray | propineb |
| | Additive: 240 | | | | into A | addition | nano- |
| | Water: 180 | | | | dilution | | suspension |
| B | Zinc sulfate: 110 | 400 | | | | | obtained; |
| | Water: 290 | | | | | | precipitation |
| | | | | | | | appeared |
| | | | | | | | after 5 hours |

Additive Used: Polyoxypropylene-polyoxyethylene block copolymer/Polyoxyethylene fatty acid ether/Polyoxyethylene castor oil ether (mass ratio 40:30:30)

### Operating Method:

Component A and Component B are each diluted and dissolved with 200 kg of water in a ratio of 4/5 and 1/5 respectively. Under stirring, the dilution of Component B is added into the dilution of Component A using a continuous spray method, yielding a transparent propineb nano-suspension. The stability duration is 5 hours.

### Embodiment 3

The propineb nano-suspension can be used to control pear scab. The active ingredient dosage is 300 g/mu, and the general dilution water volume is 300 kg. Producing 300 grams of propineb requires 270 grams of ammonium propineb.

Component Ratios: The ratios of components, dilution water volume, water distribution, addition sequence and method, and test results are presented in the table below:

| | | | Dilution | Water | | | |
|---|---|---|---|---|---|---|---|
| | Composition | Total | Water | Distribution | Addition | Addition | |
| Component | (g) | (g) | (kg) | Ratio | Order | Method | Result |
| A′ | Ammonium | 270 | 300 | 4/5 and 1/5 | Add B′ | Continuous | Transparent |
| | propineb: 270 | | | | dilution | spray | propineb |
| B′ | Zinc sulfate: 160 | 160 | | | into the | addition | nano- |
| C | Additive: 480 | 500 | | | mixed | | suspension |
| | Water: 20 | | | | dilution | | obtained; |
| | | | | | of C and | | precipitation |
| | | | | | A′ | | appeared |
| | | | | | | | after 4 hours |

Additive Used: Polyoxypropylene-polyoxyethylene alkylaryl ether/Polyoxyethylene castor oil ether/Tween-80 (mass ratio 30:30:40)

### Operating Method:

Component C and Component B′ are each diluted with water at a ratio of 4/5 and 1/5, respectively, based on a total dilution water volume of 300 kg, forming the C dilution and B′ dilution. Component A′ is then added to the C dilution and stirred evenly to form a mixed dilution of Component C and A′. While stirring, the B′ dilution is added into the mixed dilution of C and A′ by continuous spray, yielding a transparent propineb nano-suspension. Stability time is 4 hours.

### Embodiment 4

The propineb nano-suspension can be used to control northern corn leaf blight. The application dosage of the active ingredient is approximately 100 g/mu, with a typical dilution water volume of 30 kg. To generate 100 g of propineb, 90 g of ammonium propineb is required.

Component Ratios: The ratios of components, dilution water volume, water distribution, addition sequence and method, and test results are presented in the table below:

| | | | Dilution | Water | | | |
|---|---|---|---|---|---|---|---|
| | Composition | Total | Water | Distribution | Addition | Addition | |
| Component | (g) | (g) | (kg) | Ratio | Order | Method | Result |
| A | Ammonium | 350 | 40 | 2/3 and 1/3 | Add B | Continuous | Transparent |
| | propineb: 90 | | | | dilution | spray | propineb |
| | Adjuvant: 170 | | | | into A | addition | nano- |
| | Water: 90 | | | | dilution | | suspension |
| B | Zinc sulfate: 56 | 56 | | | | | obtained; |
| | | | | | | | precipitation |
| | | | | | | | appeared |
| | | | | | | | after 3.5 hours |

Additive Used: Castor oil polyoxyethylene ether/OP-10/Tween-80 (mass ratio 50/30/20)

### Operating Method:

Component A and Component B are each diluted and dissolved with water in a 2/3 and 1/3 ratio out of a total of 40 kg dilution water. Under stirring, the diluted Component B is added to the diluted Component A in a continuous spray manner, yielding a visually transparent Propineb nano-suspension. Stability duration is 3.5 hours.

### Embodiment 5

The Propineb nano-suspension can be used for the control of rice narrow brown spot. The active ingredient dosage is approximately 70 g/mu, with a typical dilution water volume of 30 kg. To generate 70 g of Propineb, 63 g of ammonium propineb is required.

Component Ratios: The ratios of components, dilution water volume, water distribution, addition sequence and method, and test results are presented in the table below:

| | | | Dilution | Water | | | |
|---|---|---|---|---|---|---|---|
| | Composition | Total | Water | Distribution | Addition | Addition | |
| Component | (g) | (g) | (kg) | Ratio | Order | Method | Result |
| A | Ammonium | 300 | 30 | 4/5 and 1/5 | Add B | Continuous | Transparent |
| | propineb: 63 | | | | dilution | dropwise | Propineb |
| | Adjuvant: 170 | | | | into A | addition | nano- |
| | Water: 67 | | | | dilution | | suspension |
| B | Zinc sulfate: 38 | 150 | | | | | obtained; |
| | Water: 112 | | | | | | precipitation |
| | | | | | | | appeared |
| | | | | | | | after 3 hours |

Additive Used: Castor oil polyoxyethylene ether/OP-10/Tween-80 (mass ratio 50/30/20)

### Operating Method:

Component A and Component B are each diluted and dissolved with 40 kg of water in a ratio of 2/3 and 1/3, respectively. Under stirring, the diluted solution of Component B is added to the diluted solution of Component A in a continuous spray manner, resulting in a transparent Propineb nano-suspension. The stability time is 3 hours.

### Embodiment 6

The Propineb nano-suspension can be used for the control of citrus anthracnose and black spot disease. The active ingredient dosage is approximately 100 g/mu, and the typical dilution water volume is 200 kg. To generate 100 g of Propineb, 90 g of ammonium propineb is required.

Component Ratios: The ratios of components, dilution water volume, water distribution, addition sequence and method, and test results are presented in the table below:

| | | | Dilution | Water | | | |
|---|---|---|---|---|---|---|---|
| | Composition | Total | Water | Distribution | Addition | Addition | |
| Component | (g) | (g) | (kg) | Ratio | Order | Method | Result |
| A′ | Propineb | 90 | 200 | 4/5 and 1/5 | Add B′ | Continuous | Transparent |
| | ammonium: 90 | | | | dilution | spray | Propineb |
| B′ | Zinc sulfate: 55 | 55 | | | into the | addition | nano- |
| C | Additive: 250 | 250 | | | mixed | | suspension |
| | | | | | dilution | | obtained; |
| | | | | | of C and | | precipitation |
| | | | | | A′ | | appeared |
| | | | | | | | after 4.5 hours |

Additive Used: OP-10/Castor oil polyoxyethylene ether/Tween-80 (mass ratio 40/40/20)

### Operating Method:

Component C and Component B′ are each diluted according to the ratio of 4/5 and 1/5 of the total 200 kg dilution water volume, respectively, to prepare the dilution solutions of Component C and Component B′. Then, Component A′ is added into the dilution solution of Component C, stirred and dispersed evenly to form a mixed dilution solution of Component C and Component A′. Under stirring, the dilution solution of Component B′ is added into the mixed dilution solution of Component C and Component A′ by continuous spray addition, resulting in a visually transparent Propineb nano-suspension. The stability time is 4.5 hours.

1. A propineb nanosuspension, characterized in that said propineb nanosuspension refers to a sub-100-nanometer propineb nanosuspension; said sub-100-nanometer propineb nanosuspension is formed by dilution and mixing of two components with water:
Component A: Water-soluble propineb salt or aqueous solution thereof, and water-soluble polymeric adjuvant; wherein said water-soluble propineb salt is selected from ammonium propineb, sodium propineb, potassium propineb, or a mixture of at least two thereof;
Component B: Zinc salt or an aqueous solution thereof in a specified mass ratio.

2. The propineb nanosuspension according to claim 1, characterized in that said sub-100-nanometer propineb nanosuspension has an hour-scale stability period.

3. The propineb nanosuspension according to claim 1, characterized in that Component B is an aqueous solution formed by adding water-soluble polymeric adjuvant and water.

4. The propineb nanosuspension according to claim 1, characterized in that said water-soluble polymeric adjuvant is a nonionic surfactant.

5. The propineb nanosuspension according to claim 1, characterized in that the mass ratio of said water-soluble polymeric adjuvant to dilution water is not greater than 1:1200.

6. The propineb nanosuspension according to claim 4, characterized in that said nonionic surfactant is selected from at least one of: water-soluble starch and its derivatives, water-soluble guar gum and its derivatives, polyoxypropylene-polyoxyethylene block copolymers, fatty alcohol polyoxyethylene ethers, alkylphenol polyoxyethylene ethers, OP-10, alkyl aryl polyoxypropylene polyoxyethylene ethers, castor oil polyoxyethylene ethers, alkyl polyglucosides, Tween, and polyvinyl alcohol.

7. The propineb nanosuspension according to any one of claims 1 to 6, characterized in that said zinc salt is selected from at least one of: zinc sulfate, zinc acetate, zinc chloride, and zinc nitrate.

8. The propineb nanosuspension according to any one of claims 1 to 6, characterized in that when said propineb salt and zinc salt are ammonium propineb and zinc sulfate, respectively, their mass ratio ranges are:
$$Ammonium propineb : Zinc sulfate = 1 : 0.5 - 1.01 ;$$
$$Preferably , Ammonium propineb : Zinc sulfate = 1 : 0.9 - 1. .$$

9. A propineb nanosuspension, characterized in that said propineb nanosuspension refers to a sub-100-nanometer nanosuspension; said sub-100-nanometer propineb nanosuspension is formed by dilution and mixing of three components with water:
Component A: Solid ammonium propineb and/or sodium propineb and/or potassium propineb, or an aqueous solution thereof;
Component B: Solid zinc salt or an aqueous solution thereof, in a specified ratio;
Component C: At least one water-soluble surfactant or an aqueous solution thereof.

10. The propineb nanosuspension according to claim 9, characterized in that the mass ratio of said water-soluble surfactant to dilution water is not greater than 1:1200.

11. The propineb nanosuspension according to claim 9, characterized in that said sub-100-nanometer propineb nanosuspension has an hour-scale stability period.

12. The propineb nanosuspension according to claim 9, characterized in that Component B consists of an inorganic zinc salt or its aqueous solution.

13. The propineb nanosuspension according to claim 12, characterized in that the zinc salt is selected from at least one of: zinc sulfate, zinc acetate, zinc chloride, and zinc nitrate.

14. The propineb nanosuspension according to claim 9, characterized in that the water-soluble surfactant is selected from polymeric surfactants and/or low molecular weight surfactants.

15. The propineb nanosuspension according to claim 14, characterized in that the polymeric surfactant is a nonionic surfactant.

16. The propineb nanosuspension according to claim 15, characterized in that the nonionic surfactant is selected from derivatives of polyoxyethylene polymers, nonionic derivatives of water-soluble starch, cellulose, chitosan, dextrin, methyl ethyl cellulose, and chitosan with a deacetylation degree of about 50%, as well as polyol derivatives such as Tween, alkyl polyglucosides, or from synthetic high molecular weight products such as polyvinyl alcohol and polyvinylpyrrolidone.

17. A preparation method for the propineb nanosuspension according to any one of claims 1 to 6, characterized in that under a stirring speed not less than the effective stirring speed, Component A dilution is added to Component B dilution; or Component B dilution is added to Component A dilution, to form the propineb nanosuspension;
wherein the Component A dilution and Component B dilution are aqueous solutions formed by dilution of Component A and Component B with water.

18. The preparation method according to claim 17, characterized in that the mode of adding one component to the other is selected from one of the following four methods: continuous addition, intermittent portion-wise addition, dropwise addition, or spray addition.
